(19) United States
(12) Patent Application Publication
(10) Pub. No.: US 2014/0172748 A1
(43) Pub. Date: Jun. 19, 2014

(54) Liquidity Margin

(71) Applicant: CHICAGO MERCANTILE EXCHANGE INC., Chicago, IL (US)

(72) Inventors: Michal Koblas, Chicago, IL (US); Moody Hadi, Chicago, IL (US); Panagiotis Xythalis, Chicago, IL (US)

(73) Assignee: CHICAGO MERCANTILE EXCHANGE INC., Chicago, IL (US)

(21) Appl. No.: 13/720,338

(22) Filed: Dec. 19, 2012

(51) Int. Cl. G06Q 40/06

(52) U.S. Cl. CPC G06Q 40/06
USPC 705/36 R

(57) ABSTRACT

Systems and methods are provided for determining margin requirements for portfolios that are illiquid or have concentrated positions. Surveys with sample portfolios that include credit default swaps and that ask for liquidity charges are distributed to clearing members. Answers to the surveys are analyzed to develop a liquidity risk model. The liquidity risk model is subsequently used when setting margin requirements.

### FIELD OF THE INVENTION

Aspects of the invention relate to determining risks and margin requirements. More particularly, aspects of the invention relate to determining costs associated with liquidity risks.

### BACKGROUND

Exchanges are typically associated with clearing houses that are responsible for settling trading accounts, clearing trades, collecting and maintaining performance bond funds, regulating delivery and reporting trading data. Clearing is the procedure through which the clearing house becomes buyer to each seller of a contract, and seller to each buyer, and assumes responsibility for protecting buyers and sellers from financial loss by assuring performance on each contract. This is effected through the clearing process, whereby transactions are matched.

Clearing houses establish clearing level performance bonds (margins) for traded financial products and establishes minimum performance bond requirements for customers. A performance bond, also referred to as a margin, is the funds that may be required to deposited by a customer with his or her broker, by a broker with a clearing member or by a clearing member with the clearing house, for the purpose of insuring the broker or clearing house against loss on open contracts. The performance bond is not a part payment on a purchase and helps to ensure the financial integrity of brokers, clearing members and exchanges or other trading entities as a whole. A performance bond to clearing house refers to the minimum dollar deposit which is required by the clearing house from clearing members in accordance with their positions. Maintenance, or maintenance margin, refers to a sum, usually smaller than the initial performance bond, which must remain on deposit in the customer's account for any position at all times. In order to minimize risk to an exchange or other trading entity while minimizing the burden on members, it is desirable to approximate the requisite performance bond or margin requirement as closely as possible to the actual risk of the account at any given time.

Risks and margin requirements can be difficult to determine for illiquid and concentrated positions. Illiquid positions do not allow a clearing house to quickly liquidate positions, which makes it difficult to value risks. Concentrated positions can make it difficult for a clearing house or other entity to find a buyer or seller. Accordingly, there is a need in the art for systems and methods for determining risks and margin requirements for illiquid and concentrated positions.

### SUMMARY OF THE INVENTION

Aspects of the invention overcomes at least some of the problems and limitations of the prior art by providing systems and methods for valuing risks and margin requirements for portfolios that are illiquid or have concentrated positions. Surveys with sample portfolios that include credit default swaps and that ask for liquidity charges are distributed to clearing members. Answers to the surveys are analyzed to develop a liquidity risk model. The model may include the higher of a concentration based liquidity charge which takes into account the effect of portfolio risk and a floor liquidity charge based on bid-ask spreads for positions in the portfolio.

In some embodiments of the invention the concentration based liquidity charge includes the sum of a concentration charge for market exposure and a concentration charge for the basis of the portfolio.

In other embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIG. 1 shows a computer network system that may be used to implement aspects of the present invention.

FIG. 2 illustrates a process that may be used to determine risks associated with a portfolio of financial products, in accordance with an embodiment of the invention.

FIG. 3 illustrates exemplary factors that may be part of a multi-factor margin model, in accordance with an embodiment of the invention.

FIG. 4 illustrates a method that may be used to create model for quantifying liquidity risks in accordance with an embodiment of the invention.

### DETAILED DESCRIPTION

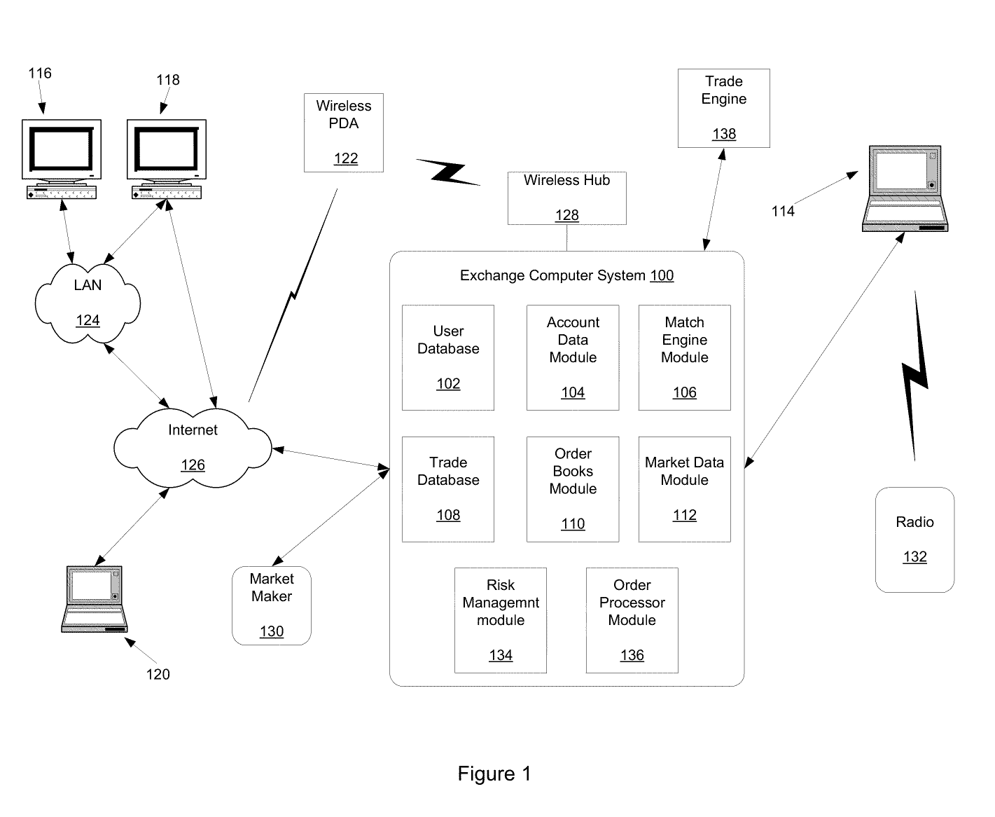

Aspects of the present invention are preferably implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

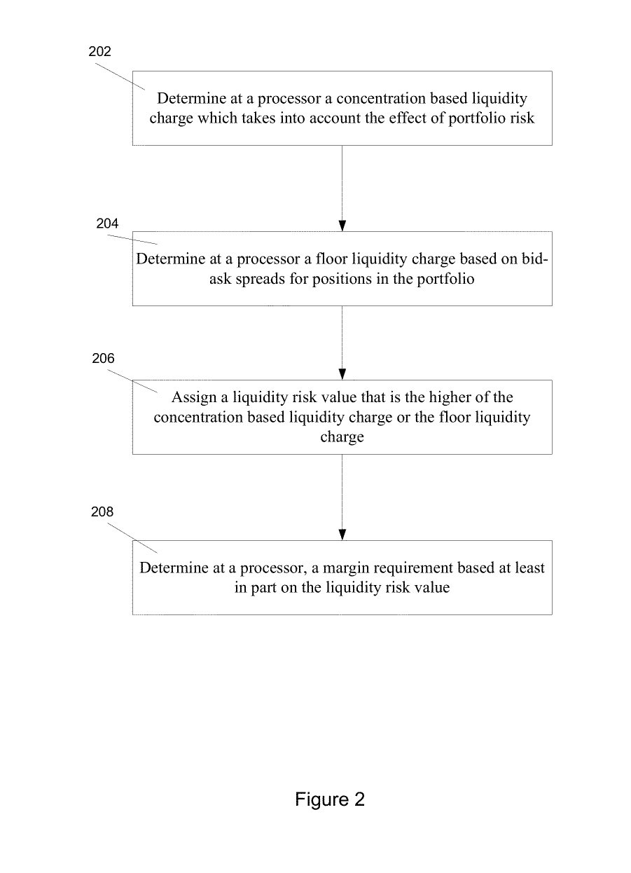

FIG. 2 illustrates a process that may be used to determine risks associated with a portfolio of financial products. The financial products may be illiquid or subject to concentrated ownership. In some embodiments the financial products include credit default swaps. A credit default swap is a financial swap that the seller of the credit default swap will compensate the buyer in the event of a loan default or other credit event. First, in step 202 a concentration based liquidity charge which takes into account the effect of portfolio risk is determined. Step 202 may be performed by a processor.

The concentration based liquidity charge may include or consist of the sum of a concentration charge for market exposure and a concentration charge for the basis of the portfolio. The concentration charge for market exposure may be a function of absolute SDV01. SDV01 represents a portfolio sensitivity to a 1% par spread shock. In one embodiment the concentration charge for market exposure is:

a*Abs(SDV)̂1.5 (Equation 1)

The constant “a” in Equation 1 represents the cost of neutralizing market risk through offsetting positions. Exemplary costs of neutralize market risks include the cost of hedging a portfolio. A method for assigning a value to “a” is described below.

The concentration charge for the basis of the portfolio may be a function of RSDV01. RSDV01 is the difference between the sum of absolute SDV01's of individual financial instrument positions and absolute SDV01. In one embodiment the concentration charge for the basis of the portfolio is:

b*RSDV̂1.5 (Equation 2)

The constant “b” represents the cost of liquidating a remaining portfolio. Exemplary costs of liquidating a remaining portfolio include the cost of unwinding a market neutral portfolio.

In step 204 a floor liquidity charge based on bid-ask spreads for positions is determined. Step 204 may be performed at a processor. In one embodiment, the floor liquidity charge is:

Sum of {Gross Notional*DST*Bid/Ask(OTR 5year)*PV01(OTR 5year)} across the portfolio's positions. (Equation 3)

Wherein:
Gross Notional=Gross Notional of the portfolio
DST=Duration Series Tenor
OTR 5year=Bid Ask spread of the 5 year on-the-run series
PV01=Present Value of 1 basis point move

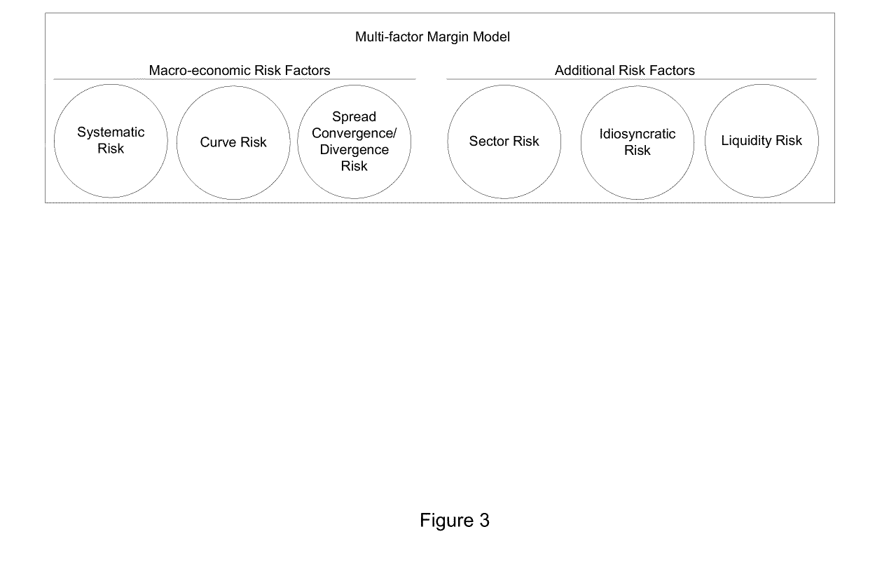

In step 206 a liquidity risk value is assigned may that is the higher of the concentration based liquidity charge or the floor liquidity charge. Step 206 may also be performed by a processor. Finally, in step 208 a margin requirement may be determined that is based at least in part on the liquidity risk value. Steps 206 and 208 may also be performed by one or more processors. Those skilled in the art will appreciate that that there are many conventional models and methods that may be used to determined margin requirements. FIG. 3 illustrates exemplary factors that may be part of a multi-factor margin model. A model may include macro-economic risk factors such as systemic risk, curve risk and spread convergence/divergence risk factors. Additional factors may include sector risk and idiosyncratic risk factors.

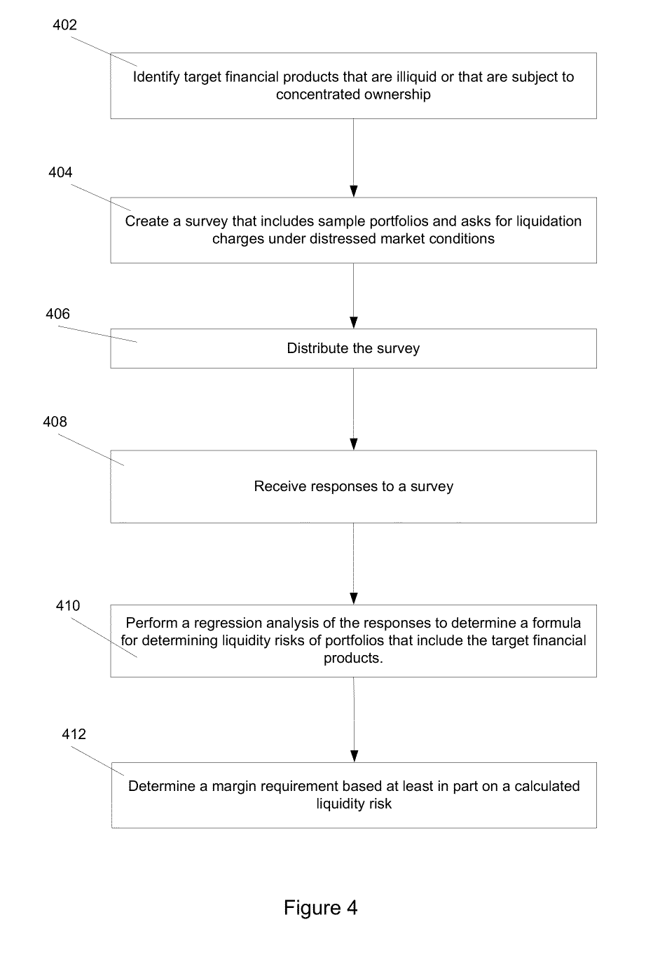

Selecting appropriate models to quantity risks and set margin requirements can be difficult when portfolios include financial products that are illiquid or subject to concentrated ownership. FIG. 4 illustrates a method that may be used to create a model for quantifying liquidity risks in accordance with an embodiment of the invention. The method may use responses to survey questions and a regression analysis to set values of constants. First, in step 402, target financial products that are illiquid or that are subject to concentrated ownership are identified. The target financial products may be part of a portfolio of financial products. Next a survey that includes sample portfolios and that asks for liquidation risks or charges under distressed market conditions is created in step 404.

The liquidation charge may be the difference between the portfolio's mid par price valuation and the actual market bid on the portfolio. The liquidation charge may take into account the liquidity of the portfolio instruments and the size of the instrument positions. The survey is distributed in step 406. The survey may be distributed to members of an exchange, customers of a clearing house and/or to others. After the surveys are completed, they are received at in step 408. The surveys may be received at computer device, such as server connected to a computer network.

After the surveys are received, the responses may be analyzed to create or adjust a model. For example, in step 410 a regression analysis of the responses is performed to determine a formula for determining liquidity risks of portfolios that include the target financial products. The regression analysis may be performed by a processor. Other types of statistical analysis may be performed instead of or in addition to the regression analysis. In some embodiments a regression analysis is used to determine constants “a” and “b” in equations 1 and 2. The responses may also be used to determine discounts considered for the basis or curve portfolios and concentration surcharges imposed on excessively large portfolios. In some embodiments a determination of when a portfolio is concentrated may also be determined from analyzing the survey results.

The present invention has been described in terms of preferred and exemplary embodiments thereof. Numerous other embodiments, modifications and variations within the scope and spirit of the invention will occur to persons of ordinary skill in the art from a review of this disclosure. For example, aspects of the invention may be used to process and communicate data other than market data.

1. A method of determining risks associated with a portfolio of financial instruments, the method comprising:
(a) determining at a processor a concentration based liquidity charge which takes into account the effect of portfolio risk;
(b) determining at a processor a floor liquidity charge based on bid-ask spreads for positions in the portfolio; and
(c) assigning a liquidity risk value that is the higher of the concentration based liquidity charge or the floor liquidity charge.

2. The method of claim 1, wherein the concentration based liquidity charge comprises the sum of:
(i) a concentration charge for market exposure; and
(ii) a concentration charge for the basis of the portfolio.

3. The method of claim 2, wherein (i) comprises a concentration charge for market exposure as a function of absolute SDV01, wherein SDV01 represents a portfolio sensitivity to a 1% par spread shock.

4. The method of claim 3, wherein (i) comprises:
a*Abs(SDV)̂1.5, wherein “a” represents the cost of neutralizing market risk through offsetting positions.

5. The method of claim 2, wherein (ii) comprises a concentration charge for the basis of the portfolio as a function of RSDV01, wherein RSDV01 is the difference between the sum of absolute SDV01's of individual financial instrument positions and absolute SDV01.

6. The method of claim 5, wherein (ii) comprises:
b*RSDV̂1.5, wherein “b” represents the cost of liquidating the remaining portfolio.

7. The method of claim 2, wherein:
(i) comprises a*Abs(SDV)̂1.5, wherein “a” represents the cost of neutralizing market risk through offsetting positions; and
(ii) comprises b*RSDV̂1.5, wherein “b” represents the cost of liquidating the remaining portfolio.

8. The method of claim 1, wherein the floor liquidity charge comprises:
Sum of {Gross Notional*DST*Bid/Ask(OTR 5year)*PV01 (OTR 5year)} across the portfolio's positions.

9. The method of claim 1, wherein:
(i) the concentration based liquidity charge comprises:
a*Abs(SDV)̂1.5+b*RSDV̂1.5, wherein “a” represents the cost of neutralizing market risk through offsetting positions and “b” represents the cost of liquidating the remaining portfolio and;
(ii) the floor liquidity charge comprises:
Sum of {Gross Notional*DST*Bid/Ask (OTR 5year)*PV01 (OTR 5year)} across the portfolio's positions.

10. The method of claim 1, further comprising:
(d) determining, at a processor, a margin requirement based at least in part on the liquidity risk value.

11. The method of claim 10, wherein the margin requirement is based at least in part on the liquidity risk value and macro-economic risk factors.

12. The method of claim 1, wherein the portfolio of financial instruments comprises derivative products.

13. The method of claim 1, wherein the portfolio of financial instruments comprises credit default swaps.

14. A method comprising:
(a) identifying target financial products that are illiquid or that are subject to concentrated ownership;
(b) receiving responses to a survey that asks respondents to estimate liquidity risks for portfolios that include the financial products in (a);
(c) performing, at a processor, a regression analysis of the responses received in (b) to determine a formula for determining liquidity risks of portfolios that include the target financial products in (a).

15. The method of claim 14, wherein the formula comprises:
a*Abs(SDV)̂1.5+b*RSDV̂1.5, wherein “a” and “b” are determined by the regression analysis and “a” represents the cost of neutralizing market risk through offsetting positions and “b” represents the cost of liquidating a remaining portfolio.

16. The method of claim 15, further including:
(d) determining a margin requirement based at least in part on a calculated liquidity risk.

17. A non-transitory tangible computer-readable medium that when executed cause a computer device to perform the steps comprising:
(a) determining a concentration based liquidity charge which takes into account the effect of portfolio risk;
(b) determining a floor liquidity charge based on bid-ask spreads for positions in the portfolio; and
(c) assigning a liquidity risk value that is the higher of the concentration based liquidity charge or the floor liquidity charge.

18. The non-transitory tangible computer-readable medium of claim 17, wherein the concentration based liquidity charge comprises the sum of:
(i) a concentration charge for market exposure; and
(ii) a concentration charge for the basis of the portfolio.

19. The non-transitory tangible computer-readable medium of claim 18, wherein (i) comprises:
a*Abs(SDV)̂1.5, wherein “a” represents the cost of neutralizing market risk through offsetting positions.

20. The non-transitory tangible computer-readable medium of claim 19, wherein (ii) comprises:
b*RSDV̂1.5, wherein “b” represents the cost of liquidating the remaining portfolio.
